(19) United States
(12) Patent Application Publication
(10) Pub. No.: US 2014/0380457 A1
(43) Pub. Date: Dec. 25, 2014

(54) ADJUSTING DDOS PROTECTION

(71) Applicants: Chris Cassell, Ann Arbor, MI (US); Jeffrey Doppke, Canton, MI (US); Kevin Russell Cline, Ann Arbor, MI (US)

(72) Inventors: Chris Cassell, Ann Arbor, MI (US); Jeffrey Doppke, Canton, MI (US); Kevin Russell Cline, Ann Arbor, MI (US)

(73) Assignee: ARBOR NETWORKS, INC., Sunnyvale, CA (US)

(21) Appl. No.: 13/923,875

(22) Filed: Jun. 21, 2013

(51) Int. Cl. H04L 29/06

(52) U.S. Cl. CPC H04L 63/0236
USPC 726/13

(57) ABSTRACT

A system, method and computer readable storage medium that blocks network traffic exceeding a user selected value. Received data packets are analyzed to determine volumetric traffic flow so as to graphical represent the determined volumetric traffic flow for the received data packets on a display device. A countermeasure filter is provided having at least one traffic setting operational to block data packet traffic flow from the one or more external devices when the volumetric data packet flow exceeds a prescribed threshold value. The prescribed threshold value is determined by a user positioned indicator on a display device graphically representing the determined volumetric traffic flow.

### FIELD OF THE INVENTION

The present invention relates generally to computer networks, and more specifically to methods and systems for protecting against denial of service attacks in computer networks by adjusting attack countermeasures.

### BACKGROUND OF THE INVENTION

The Internet is a global public network of interconnected computer networks that utilize a standard set of communication and configuration protocols. It consists of many private, public, business, school, and government networks. Within each of the different networks are numerous host devices such as workstations, servers, cellular phones, portable computer devices, to name a few examples. These host devices are able to connect to devices within their own network or to other devices within different networks through communication devices such as hubs, switches, routers, and firewalls, to list a few examples.

The growing problems associated with security exploits within the architecture of the Internet are of significant concern to network providers. Networks, and network devices are increasingly affected by the damages caused by Denial of Service (“DoS”) attacks. A DoS attack is defined as an action taken upon on a computer network or system by an offensive external device that prevents any part of the network from functioning in accordance with its intended purpose. This attack may cause a loss of service to the users of the network and its network devices. For example, the loss of network services may be achieved by flooding the system to prevent the normal servicing for performing legitimate requests. The flooding may consume all of the available bandwidth of the targeted network or it may exhaust the computational resources of the targeted system.

A Distributed Denial of Service (“DDoS”) attack is a more aggressive action that involves multiple offensive devices performing an attack on a single target computer network or system. This attack may be performed in a coordinated manner by these multiple external devices to attack a specific resource of a service provider network. The targeted resource can be any networking device such as routers, Internet servers, electronic mail servers, Domain Name System (“DNS”) servers, etc. Examples of a DDoS attack include (but are not limited to): large quantities of raw traffic designed to overwhelm a resource or infrastructure; application specific traffic designed to overwhelm a particular service; traffic formatted to disrupt a host from normal processing; traffic reflected and/or amplified through legitimate hosts; traffic originating from compromised sources or from spoofed IP addresses; and pulsed attacks (which start/stop attacks). Further, it is to be understood DDoS attacks are typically categorized as: TCP Stack Flood Attacks (e.g., flood a certain aspect of a TCP connection process to keep the host from being able to respond to legitimate connections (which may also be spoofed)); Generic Flood Attacks (e.g., consists of a flood of traffic for one or more protocols or ports, which may be designed to appear like normal traffic which may also be spoofed)); Fragmentation Attacks (e.g., consists of a flood of TCP or UDP fragments sent to a victim to overwhelm the victim's ability to re-assemble data streams, thus severely reducing performance); Application Attacks (e.g., attacks designed to overwhelm components of specific applications); Connection Attacks (e.g., attacks that maintain a large number of either ½ open TCP connections or fully open idle connections); and Vulnerability Exploit Attacks (e.g., attacks designed to exploit a vulnerability in a victim's operating system).

The architecture of the Internet makes networks and network devices vulnerable to the growing problems of DDoS attacks. Therefore, the ability to avoid or mitigate the damages of a DDoS attack is advantageous to devices located in a protected network.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings.

To achieve these and other advantages and in accordance with the purpose of the invention, as embodied, the invention includes, a system, method and computer readable storage medium in which an aspect of the invention includes receiving data packets from one or more external devices attempting to access protected devices in the protected network. The received data packets are analyzed to determine volumetric traffic flow for the received data packets, which determined volumetric traffic flow is graphically represented on a display device, which may be presented in a histogram. A rate limiting countermeasure filter is preferably provided having a plurality of traffic settings each traffic setting operational to block data packet traffic flow from the one or more external devices. Each traffic setting is determined by a user positioned indicator displayed on the display device graphically representing volumetric traffic flow for the data packets received from the one or more external devices. Each traffic setting is prescribed independent of one another. A user is enabled to select one of the plurality of traffic settings for enabling the countermeasure filter to block data packet traffic flow received from the one or more external devices when the volumetric data packet flow exceeds a prescribed threshold value as determined by the user positioned indicator associated with the selected traffic setting.

### BRIEF DESCRIPTION OF THE DRAWINGS

The accompanying appendices and/or drawings illustrate various non-limiting, example, inventive aspects in accordance with the present disclosure:

FIG. 1 illustrates an exemplary network communications system, in which an embodiment of the present invention may be implemented;

FIG. 2 illustrates an exemplary method for protecting against a denial of service attack according to the present invention;

FIGS. 3 and 4 illustrate various computer display screens generated by an embodiment of the present invention; and

FIGS. 5A and 5B illustrate additional computer display screens generated by an embodiment of the present invention.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

It is to be further understood the illustrated embodiments of the present invention describe a system, apparatus and method for avoiding and mitigating the harmful effects of a Distributed Denial of Service (“DDoS”) attack on a computer system/device or network. An ordinary denial of service attack, or DoS attack, may be defined as an attack by an offensive external device on a network device such as network routers, Internet servers, electronic mail servers, Domain Name System servers, etc. Such an attack may cause a loss of service to the network users due to a consumption of network bandwidth or an overload of system resources. The DDoS attack is an enhanced DoS attack in which multiple offensive devices coordinate a simultaneous attack upon a single targeted network device.

It is to be appreciated that an illustrated use of the illustrated system and process described herein is with the PRAVAIL™ Availability Protection System (PRAVAIL™ APS) from Arbor® Networks. PRAVAIL™ APS is a network security product configured and adapted for generally preventing DDoS attacks and availability threats that affect data centers and enterprise networks. PRAVAIL™ APS may be deployed by network/data center operators in front of services to stop application-layer attacks and disrupt botnet communications. PRAVAIL™ APS may further be integrated upstream in a network/date center to preferably stop thwart volumetric DDoS attacks. Features of PRAVAIL™ APS include (but are not limited to): detecting and blocking emerging application-layer DDoS attacks; deploy a turnkey solution to thwart DDoS threats; accelerate responses to DDoS attacks to prevent disruption of legitimate services; and prevent illegitimate botnet communications by leveraging real-time security intelligence, as to be described herein for instance.

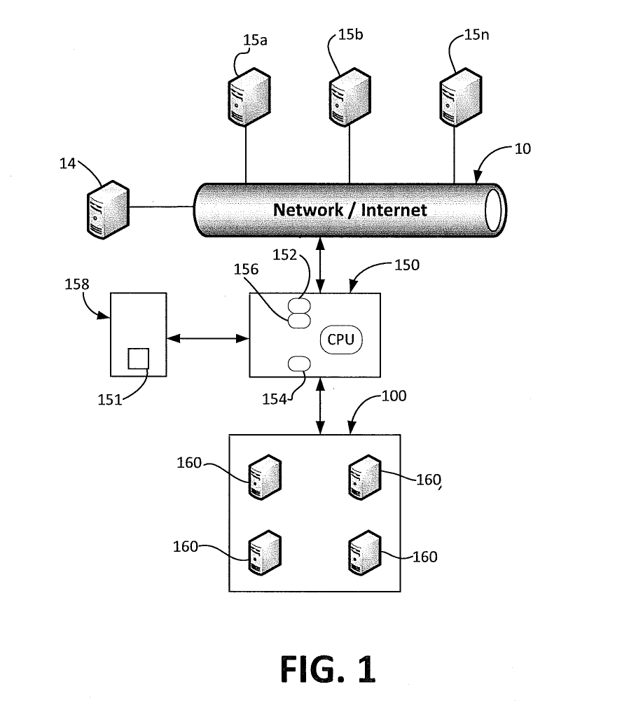

Turning now descriptively to the drawings, in which similar reference characters denote similar elements throughout the several views, FIG. 1 illustrates the relationship between the protected network 100, protection system 150, Internet 10, and external host devices 15a, 15b . . . 15n. It is to be appreciated that protected network 100 preferably includes a plurality of servers 160 preferably consisting of a plurality of server types, including, but not limited to: Generic; Web; DNS; Mail; VOiP; VPN; RLogin; and File Servers.

In a typical implementation, the external host devices 15a, 15b . . . 15n (also referred to as external devices or host devices) attempt to connect to protected devices 160 within a protected network 100 typically via a private network or a public computer network such as the Internet 10. Examples of external host devices include servers, laptops, desktop computers, tablet devices, mobile phones, mobile computing devices, video games systems, televisions and other similar devices and systems having Internet connectivity.

In a preferred embodiment, the protected network 100 is protected by a protection system 150 preferably located between the Internet 10 and the protected network 100. Usually, the protected network 100 is an enterprise network, such as a school network, business network, and government network, to list a few examples.

In other embodiments, the protection system 150 is located within the Internet, service provider network or enterprise network rather than as a network edge as illustrated. It is to be appreciated that when deployed within the protected network, traffic is diverted to the protection system 150.

The protection system 150 preferably includes a packet processing system preferably having an external high speed network interface 152 and a protected high-speed network interface 154. Typically, these interfaces are capable of handling 1.5-40 Gbps, for example. System 150 may further include processors 156 that preferably process the packets received at interfaces 152 and 154. Additionally, a central processing unit (CPU), random access memory (RAM), and a storage medium 158 are preferably connected through buses and are used to further support the processing of the received packets. Computer code is preferably stored in the storage medium and executed by the CPU. In one illustrated embodiment, the storage medium 158 may preferably include content-addressable memory (CAM), which is memory designed for use in very high speed searching applications. It is noted CAM memory operates different from the more commonly used random access memory (RAM). With RAM memory a memory address is specified and the data stored at that address is returned. With CAM memory, the entire memory is searched to see if specified data are stored anywhere in the memory. The storage medium 158 also preferably stores the host tables 151 used in the below described authenticated process of external device hosts 15a, 15b . . . 15n as well as other possible information such as predefined filter rules.

In a typical implementation, the protection system 150 authenticates all external host devices 15a, 15b . . . 15n before allowing the external devices to access the protected devices 160 within the protected network 100.

During an attack, the protection system 150 seeks to distinguish between attack traffic 14 and traffic made by legitimate host devices 15a, 15b . . . 15n by analyzing traffic to determine traffic (packet) classifications which are subsequently used to determine countermeasures (preferably of varying severity to mitigate attack), which are to be applied to received packets in the traffic, prior to accessing the protected devices 160 within the protected network 100. Thus, a goal of the protection system 150 is to selectively apply/modify one or more countermeasures to a determined traffic class/category to prevent traffic 14 from malicious devices from accessing the protected network 100.

It is to be understood and appreciated countermeasures are various defense mechanism's formatted to target and remove egregious attack traffic while permitting a network to continue operating wherein different countermeasures are designed to stop different types of attack traffic. Countermeasures are typically categorized as Raw and Event Driven countermeasures in which Raw countermeasures are preferably applied to each packet that transmits through a protection system 150. In contrast, Event Driven Countermeasures are not applied to each packet that transmits through a protection system 150. A protection system 150 preferably identifies the traffic stream with an application ID before an Event Driven countermeasure is applied wherein a protection system 150 may re-assemble a traffic stream (can be multiple packets) and notifies the appropriate countermeasure to inspect the traffic stream.

To gain an generally understanding for thwarting DDoS attacks, raw countermeasures include (but are not limited to): Global Exception (e.g., a global exception list) and Black/White Listing (e.g., identifies which traffic will be immediately dropped and which traffic will be automatically passed without further scrutiny); Zombie Removal (e.g., source addresses (hosts) that exceed a pps or bps threshold are blacklisted and all packets from them are dropped until they fall below a threshold rate); TCP SYN Authentication (e.g., system 150 intercepts all new inbound TCP session to verify they are not SYN floods wherein system 150 responds to a TCP SYN with a SYN ACK preferably having a unique sequence number such that the host responds with the unique sequence number +1 to authenticate the session. System 150 then preferably resets the session enabling the host to establish new sessions directly with the server until it meets an Idle timeout); DNS Authentication (e.g., used to block randomized UDP DNS floods whereby system 150 drops a first DNS request from a host and if the host re-transmits the request, system 150 marks the host as valid and permits passage of the request—once validated, all subsequent DNS requests from that host pass through until no DNS requests are detected from that host for an authentication period timeout); TCP Connection Reset (e.g., system 150 monitors TCP sessions and resets them if they remain idle for a TCP connection idle timeout period wherein an offending host is preferably temporarily blacklisted (e.g., 5 minutes)); Payload Regex Filtering (e.g., if a packet matches a destination port and the payload matches a regular expression, the packet is dropped); Baseline Enforcement (e.g., the system 150 preferably conducts two types of enforcement, 1) bandwidth enforcement and 2) protocol enforcement)); Malformed DNS Filtering (payload only) (e.g., detection is preferably performed on packets transmitted over DNS ports (e.g., TCP 53 and UDP 53) wherein any UDP ports 53 packets containing no payload are dropped and decoded DNS packets not formed properly are also dropped); SIP Malformed (e.g., payload check only); and Rate Limiting (e.g., all traffic exceeding prescribed threshold rates for Bits Per Second (BPS) and Packets Per Second (PPS) are dropped).

With regards to Event Driven countermeasures, they may include (but are not limited to): Malformed DNS Filtering (e.g., detection is only performed on packets transmitted over the DNS ports (TCP and UDP 53) whereby any UDP port 53 packet containing no payload are dropped and decoded DNS packets not formed properly are also dropped); Malformed HTTP Filtering (e.g., packets must preferably conform to RFC2616 Section 2.2 “Basic Rules with the exception of permitting the” “character such that hosts are monitored to verify that the HTTP headers are properly formed); HTTP Object and Request Rate Limiting (e.g., limits the number of requests per second a single client can request and limits the number of objects per second a single client can request whereby an offending host is preferably blacklisted for a prescribed time period (e.g., five minutes)); HTTP Regex Filtering (e.g., the HTTP Header Regex is a regular expression that system 150 preferably applies separately to each line of any HTTP header or HTTP request that enter a mitigation process whereby if either the request or any line of the header matches the expression, the packet is dropped whereby an offending host is preferably blacklisted for a prescribed time period (e.g., five minutes)); Malformed SIP Filtering; and SIP Rate Limiting (e.g., any UDP SIP packets containing no payload are dropped and improperly formed packets are dropped and an offending host is preferably blacklisted for a prescribed time period (e.g., five minutes)).

For purposes of the present invention, Rate Limiting and like countermeasures are further described below.

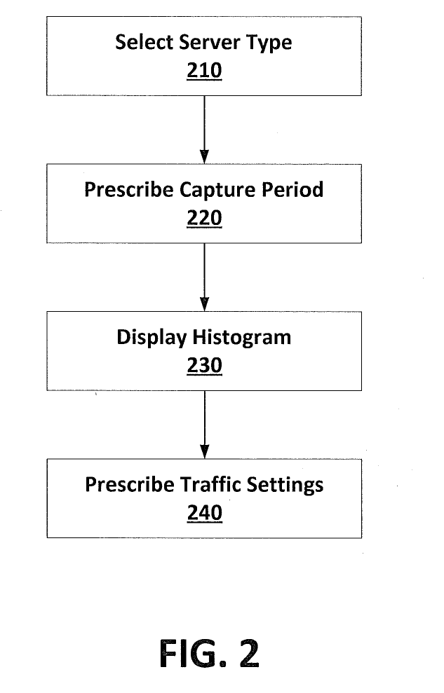

FIG. 2 shows an illustrative method 200 for enabling protection system 150 to protect against a DDoS attack through use and configuration of a rate limiting countermeasure filter operational to block/prevent attack data packet flow traffic from a external host devices 15a, 15b . . . 15n when data packet travel exceeds a user selected threshold value. It should be noted that throughout this description, it has been assumed that the system and method of the present invention uses a single provider edge router (PE) router to protect against a DDoS attack. However, it may be that there is a plurality of PE routers within the network that may functionally cooperate to perform the method of the present invention. For example, a network may include a plurality of PE routers and all of the PE routers are implemented within an exemplary network of the present invention.

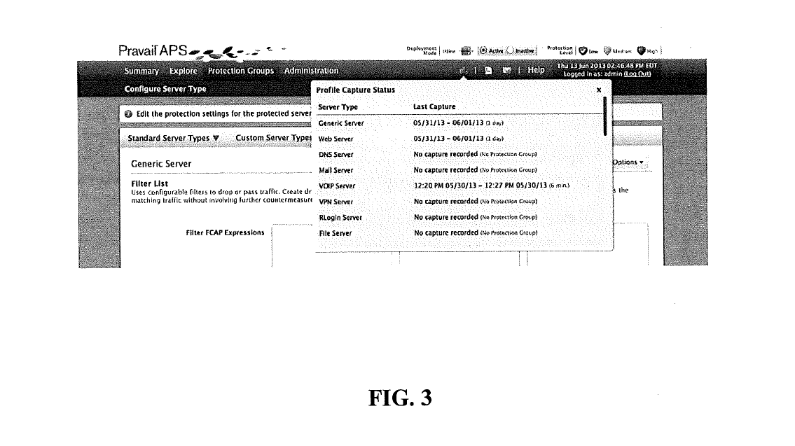

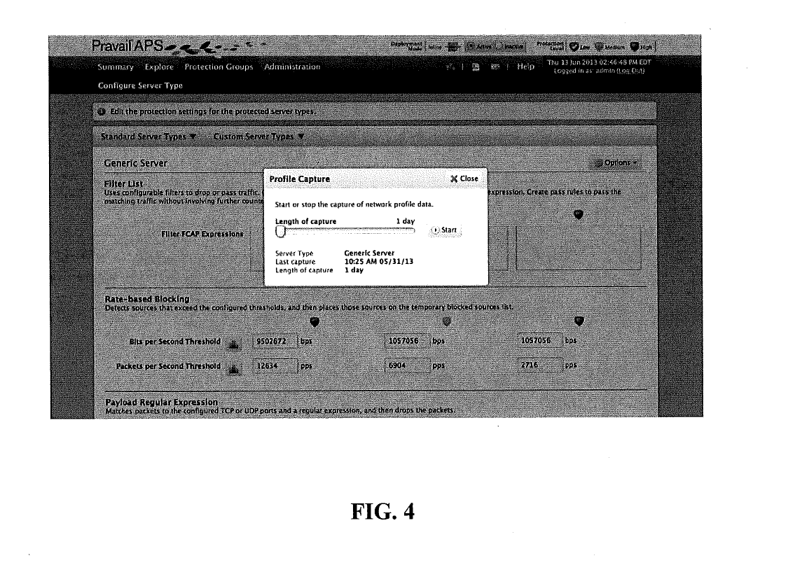

With reference now to the method for configuring a rate limiting countermeasure filter in accordance with the illustrated embodiment of FIG. 2, and in conjunction with computer display screen shots preferably generated by the CPU of protection system 150, and starting at step 210 (FIG. 3), a user first preferably selects a server type (via customary computer input devices, e.g., a mouse, keyboard, stylus device, etc.) to which the below described rate limiting filter settings are to be applicable thereto. As mentioned above, the server types include, but are not limited to: Generic; Web; DNS; Mail; VOiP; VPN; RLogin; and File Servers. Once a server type has been selected (step 210), under control of the CPU, the user preferably prescribes a length of time protection system 150 is to capture packet data flow traffic from external host devices 15a, 15b . . . 15n, step 220 (FIG. 4). For instance, in the example depicted in FIG. 4, a time period of one day is selected for capturing data packet flow traffic from external host devices 15a, 15b . . . 15n for filter settings associated with a Generic Server Type selected in step 210.

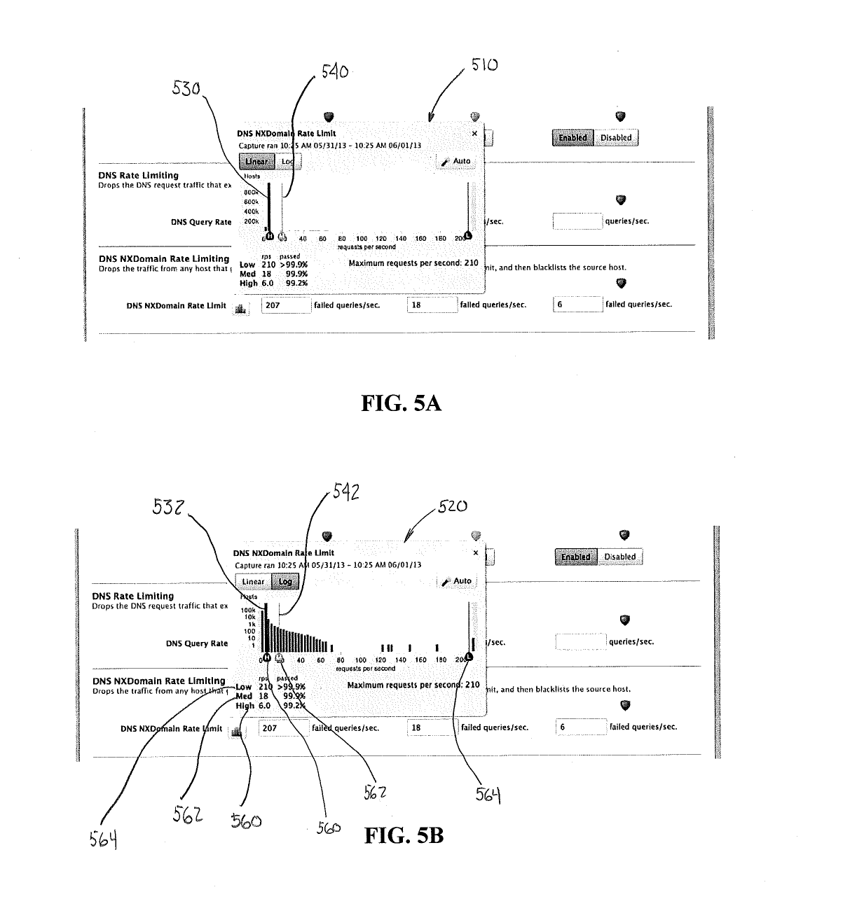

Once data packet flow traffic is available and captured by protection system 150, the CPU of the protection system 150 is configured and operational to enable a user to preferably display a histogram on a display device, step 230 (FIGS. 5A, 5B) through known methods, including (but not limited to) popover displays. In accordance with the illustrated embodiments, the histogram is visible in various user selected formats, including (but not limited to) a linear scale (FIG. 5A) and a logarithmic scale (FIG. 5B).

The histogram 510, 520 is preferably a graphical representation of network traffic from external host devices 15a, 15b . . . 15n, preferably consisting of a range of values and occurrences of those values, preferably overlaid with a drag and drop user interface thus enabling a user to visualize data traffic anomalous values so as to configure the setting of the rate limiting countermeasure filter based on these values within a visual context. It is to be appreciated that in accordance with the illustrated embodiment, the X-axis of the histogram are data packet time values, such as bits per second, packets per second, URLs (Uniform Resource Locator) per second or requests per second, and the Y-axis is the number of hosts occurrences in a particular dataset 530, 532, wherein the values of each axis are scalable to provide an enhanced visualization of anomalies, when desired. It is to be appreciated vertical markers 540, 542 are preferably positioned on top of the graphed data (initially over pre-configured values). Each of these marker 540, 542 may be dragged horizontally by a user (preferably via a mouse device), and while being dragged they provide values under their position on the graph to a data model in the CPU of the protection system 150 updating the settings of the rate limiting filter, as described further below.

It is to be appreciated a rate limiting filter may have one or more settings for blocking packet data traffic when it exceeds one or more user selected threshold values. For instance, and with particular reference to FIG. 5B, the rate limiting filter has three settings, a high 560, medium 562 and low 564. Each setting is prescribed by user via the user dragging each setting indicator (560, 562 and 564) horizontally along the X-axis to a value which is desired by a user for a particular threat level. For instance, as shown in FIG. 5B, a high threat level is prescribed at a maximum of 6 requests per second, a medium threat level is prescribed at a maximum of 18 requests per second, and a low threat level is prescribed at a maximum of 210 requests per second. Thus, when the high threat level (560) is enabled, data packet traffic is blocked from all hosts requesting more than 6 requests per second, when the medium threat level (562) is enabled, data packet traffic is blocked from all hosts requesting more than 18 requests per second, and when the low threat level (560) is enabled, data packet is block from all hosts requesting more than 210 requests per second.

Once the filter settings for the rate limiting filter are prescribed as described above (step 230), a user enables one the aforesaid settings preferably based upon a current threat level for the protected network. Thus, during a low threat level period, a user may preferably select the rate limiting filter to filter data packet traffic in accordance with the low filter setting (564). And conversely, during a high threat level period, a user may preferably select the rate limiting filter to filter data packet traffic in accordance with the high filter setting (560.)

With the illustrative embodiments of the invention described above, it is to be appreciated the above presents a description of a best mode contemplated for carrying out the present invention and of the manner and process of making and using it in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention. The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims.

What is claimed is:

1. A method performed by a computer system having one or more processors and memory storing one or more programs for execution by the one or more processors for handling requests to a protected network, comprising:
receiving data packets from one or more external devices attempting to access protected devices in the protected network;
analyzing the received data packets to determine volumetric traffic flow for the received data packets;
graphically representing the determined volumetric traffic flow for the received data packets from the one or more external devices on a display device;
providing a countermeasure filter having at least one traffic setting operational to block data packet traffic flow from the one or more external devices when the volumetric data packet flow exceeds a prescribed threshold value wherein the prescribed threshold value is determined by a user positioned indicator on the display device graphically representing the determined volumetric traffic flow for the received data packets from the one or more external devices.

2. A method as recited in claim 1 wherein the countermeasure filter includes a plurality of traffic settings, each traffic setting operational to block data packet traffic flow from the one or more external devices wherein each traffic setting is determined by a user positioned indicator displayed on the display device graphically representing volumetric traffic flow for the data packets received from the one or more external devices wherein each traffic setting is prescribed independent of one another.

3. A method as recited in claim 2 further including the step of a user selecting one of the plurality of traffic settings for enabling the countermeasure filter to block data packet traffic flow received from the one or more external devices when the volumetric data packet flow exceeds a prescribed threshold value as determined by the user positioned indicator associated with the selected traffic setting.

4. A method as recited in claim 1 wherein the step of graphically representing the determined volumetric traffic flow for the received data packets from the one or more external devices on a display device includes displaying a histogram depicting data packets captured during a prescribed time period.

5. A method as recited in claim 4 further including the step of a user prescribing the time period for capturing received data from the one or more external devices.

6. A method as recited in claim 1 further including the step of enabling a user to select from one of a plurality of server types located in the protected network for applying the countermeasure filter thereto.

7. A method as recited in claim 1 wherein the traffic setting visual indicator is positioned by a user on the display device using drag and drop functionality.

8. A method as recited in claim 1 wherein the prescribed value is defined at least by a bits per second value of data packets received by the one or more external devices.

9. A method as recited in claim 1 wherein the prescribed value is defined at least by a requests per second value of data packets received by the one or more external devices.

10. A method as recited in claim 1 wherein the prescribed value is defined at least by a packets per second value of data packets received by the one or more external devices.

11. A method as recited in claim 1 wherein the prescribed value is defined at least by a URLs per second value of data packets received by the one or more external devices.

12. A system for blocking network traffic based upon user selected values, comprising:
a memory;
a processor disposed in communication with said memory, and configured to issue a plurality of instructions stored in the memory, wherein the instructions issue signals to:
receive data packets from one or more external devices attempting to access protected devices in the protected network;
analyze the received data packets to determine volumetric traffic flow for the received data packets;
graphically represent the determined volumetric traffic flow for the received data packets from the one or more external devices on a display device;
provide a countermeasure filter having a plurality of traffic settings each traffic setting operational to block data packet traffic flow from the one or more external devices wherein each traffic setting is determined by a user positioned indicator displayed on the display device graphically representing volumetric traffic flow for the data packets received from the one or more external devices wherein each traffic setting is prescribed independent of one another; and
enable a user to select one of the plurality of traffic settings for enabling the countermeasure filter to block data packet traffic flow received from the one or more external devices when the volumetric data packet flow exceeds a prescribed threshold value as determined by the user positioned indicator associated with the selected traffic setting.

13. A system as recited in claim 12 wherein graphically representing the determined volumetric traffic flow for the received data packets from the one or more external devices on a display device includes displaying a histogram depicting data packets captured during a prescribed time period.

14. A system as recited in claim 13 wherein a user prescribes the time period for capturing received data from the one or more external devices.

15. A system as recited in claim 12 wherein a user selects from one of a plurality of server types located in the protected network for applying the countermeasure filter thereto.

16. A system as recited in claim 12 wherein the traffic setting visual indicator is positioned by a user on the display device using drag and drop functionality.

17. A system as recited in claim 12 wherein the prescribed value is selected from the group consisting of bits per second, requests per second, packets per second and URLs per second.

18. A non-transitory computer readable storage medium and one or more computer programs embedded therein, the computer programs comprising instructions, which when executed by a computer system, cause the computer system to:
receive data packets from one or more external devices attempting to access protected devices in the protected network;
analyze the received data packets to determine volumetric traffic flow for the received data packets;
graphically represent the determined volumetric traffic flow for the received data packets from the one or more external devices on a display device; and
provide a countermeasure filter having at least one traffic setting operational to block data packet traffic flow from the one or more external devices when the volumetric data packet flow exceeds a prescribed threshold value wherein the prescribed threshold value is determined by a user positioned indicator on the display device graphically representing the determined volumetric traffic flow for the received data packets from the one or more external devices.

19. A non-transitory computer readable storage medium as recited in claim 18 wherein the countermeasure filter includes a plurality of traffic settings, each traffic setting operational to block data packet traffic flow from the one or more external devices wherein each traffic setting is determined by a user positioned indicator displayed on the display device graphically representing volumetric traffic flow for the data packets received from the one or more external devices wherein each traffic setting is prescribed independent of one another.

20. A non-transitory computer readable storage medium as recited in claim 18 wherein graphically representing the determined volumetric traffic flow for the received data packets from the one or more external devices on a display device includes displaying a histogram depicting data packets captured during a prescribed time period.
